(19) United States
(12) Patent Application Publication
(10) Pub. No.: US 2006/0125163 A1
(43) Pub. Date: Jun. 15, 2006

(54) Screw compression spring embodied as an injection-moulded part

(76) Inventors: Friedhelm Piepenstock, Schalkmuhle (DE); Reiner Piepenstock, Schalksmuhle (DE); Peter Piepenstock, Schalksmuhle (DE)

Correspondence Address: WILLIAM COLLARD;COLLARD & ROE, P.C., 1077 NORTHERN BOULEVARD, ROSLYN, NY, 11576, US

(21) Appl. No.: 10/543,152

(22) PCT Filed: Jan. 17, 2004
(86) PCT No.: PCT/DE04/00061

§ 371 Date: Jul. 22, 2005

(30) Foreign Application Priority Data
Jan. 22, 2003 (DE) 20300922.3

(51) Int. Cl. F16F 1/06

(52) U.S. Cl. 267/166

(57) ABSTRACT

The invention relates to a screw compression spring embodied as an injection-molded part. The screw compression spring comprises a plurality of threads and planar end disks. An axial plane of the screw compression spring is oriented along the joint face of the injection mold. The sections of the threads adjacent to the joint face are less inclined than the thread pitch at least on one side.

The invention relates to a screw compression spring configured as an injection-molded part, having several windings and having planar end disks, whereby an axial plane of the screw compression spring is oriented in the parting plane of the injection mold.

A screw compression spring of this type is known from DE 44 09 443 C1. The parting plane of the injection-molding die lies in an axial plane of the screw compression spring. In the shaping of the mold chambers by means of erosion, a copper electrode in the shape of the screw compression spring is sunk into a mold chamber by half, in each instance. Adjacent to the parting plane, the profile of the winding pitch has undercuts with reference to the unmolding direction, which are disadvantageous in the mold and result in a non-uniform profile of the winding pitch of the molded screw compression spring.

The task of the invention is shaping the winding pitch of the screw compression spring in the unmolding direction without an undercut, in the region of the parting plane.

This task is accomplished, according to the invention, in that the sections of the windings that are adjacent to the parting plane demonstrate a lesser incline than the winding pitch, at least on one side.

The invention differs from the state of the art in that the wall of the winding pitch that proceeds from the parting plane, in the rising direction, is flattened off by means of a lesser incline, so that no undercut is present. As a result, perfect and undercut-free erosion of the mold chamber is possible. This shaping, with a cross-section of the winding pitch that remains the same, assures a gap-free blocking position of the screw compression spring, so that the installation height can be precisely adhered to. The screw compression spring is secured against lateral deviation. The usable spring path is increased. Unmolding of the screw pitches is facilitated, so that an efficient ratio of the injection-molding die size to the force required to hold the mold of the injection-molding machine closed is assured.

A completely uniform cross-section of the thread pitch is achieved in that the sections, as a whole, demonstrate a low incline.

Complete prevention of the undercut is ensured in that the incline of the sections essentially has the value “0.”

The undercut can be avoided, even in the case of a slight change in the cross-section, in that the wall of the sections that proceeds from the parting plane demonstrate a slight incline with a subsequent step.

Exemplary embodiments are explained using the drawings, which show:

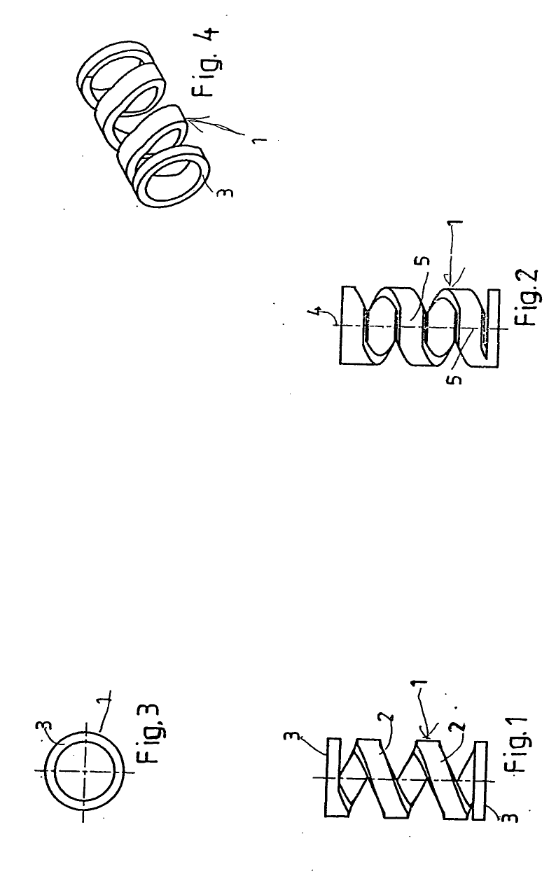

FIG. 1 a view of a first exemplary embodiment of a screw compression spring,

FIG. 2 a side view related to FIG. 1,

FIG. 3 a face view of the screw compression spring,

FIG. 4 a perspective view of the screw compression spring,

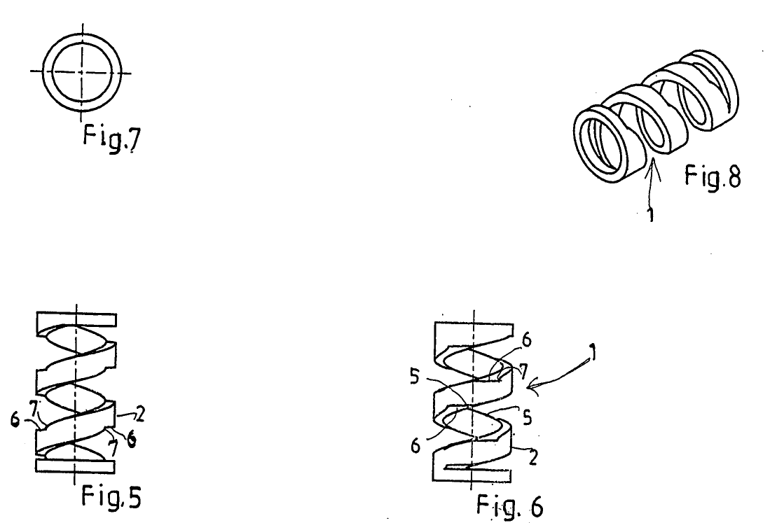

FIG. 5 a view of a second exemplary embodiment of a screw compression spring,

FIG. 6 a side view related to FIG. 5,

FIG. 7 a face view of the screw compression spring,

FIG. 8 a perspective view of the screw compression spring.

The first exemplary embodiment according to FIG. 1 to 4 shows a screw compression spring 1 as an injection-molded part having several windings 2 having a rectangular cross-section, and planar end disks 3. The parting plane 4 of the mold die is oriented perpendicular to the plane of the drawing of FIG. 2. The sections 5 of the winding pitch having a reduced incline are configured adjacent to the parting plane 4, in each instance. The incline can have the value “0.” It is directly evident from FIG. 2 that no undercut of the winding pitch are present in the region of the parting plane, in the unmolding direction. The exemplary embodiment according to FIG. 5 to 8 provides a slight incline 6 with a subsequent step 7 in the sections 5, in each instance, in the wall of the winding pitch that proceeds from the parting plane 4 and rises. This also makes it possible to avoid an undercut, as is directly evident from FIGS. 5 and 6.

1. Screw compression spring configured as an injection-molded part, having several windings and having planar end disks, whereby an axial plane of the screw compression spring is oriented in the parting plane of the injection mold, characterized in that the sections (5) of the windings (2) that are adjacent to the parting plane (4) demonstrate a lesser incline than the winding pitch, at least on one side.

2. Screw compression spring according to claim 1, characterized in that the sections (5) demonstrate a slight incline on the whole.

3. Screw compression spring according to claim 2, characterized in that the incline of the sections (5) essentially has the value “0.”

4. Screw compression spring according to claim 1, characterized in that the wall (6) of the sections (5), which proceeds from the parting plane and rises, demonstrates a slight incline with a subsequent step (7).
